(19) United States
(12) Patent Application Publication
(10) Pub. No.: US 2017/0059164 A1
(43) Pub. Date: Mar. 2, 2017

(54) GAS TURBINE WITH A SEQUENTIAL COMBUSTION ARRAGEMENT AND FUEL COMPOSITION CONTROL

(71) Applicant: ANSALDO ENERGIA IP UK LIMITED, London (GB)

(72) Inventors: Klaus KNAPP, Gebenstorf (CH); Eribert BENZ, Birmenstorf (CH); Jürgen HOFFMANN, Untersiggenthal (CH)

(73) Assignee: ANSALDO ENERGIA IP UK LIMITED, London (GB)

(21) Appl. No.: 15/247,420

(22) Filed: Aug. 25, 2016

(30) Foreign Application Priority Data
Aug. 25, 2015 (EP) 15182259.0

(51) Int. Cl. F23R 3/34; F02C 7/228

(52) U.S. Cl. CPC F23R 3/346; F02C 7/228; F05D 2220/321

(57) ABSTRACT

The present disclosure refers to a method for operating a gas turbine with a sequential combustor arrangement having: a first burner, a first combustion chamber, and a second combustor. A fuel gas is separated into a rich fuel having a concentration of higher hydrocarbons which is higher than the concentration of higher hydrocarbons of the fuel gas supplied to the plant, and a lean fuel having a concentration of higher hydrocarbons which is lower than the concentration of higher hydrocarbons of the fuel gas. A first fuel and a second fuel mixed from at least one of the rich fuel, the lean fuel, and the fuel gas are fed to different combustors of the gas turbine.

### TECHNICAL FIELD

The invention refers to a method for operating a gas turbine with a sequential combustor arrangement with fuel gas comprising higher hydrocarbons. The invention additionally refers to a gas turbine which is adapted to carry out such a method.

### BACKGROUND OF THE DISCLOSURE

Due to increased power generation by unsteady renewable sources like wind or solar existing gas turbine based power plants are increasingly used to balance power demand and to stabilize the grid. Thus improved operational flexibility is required. This implies that gas turbines are often operated at lower load than the base load design point, i.e. at lower combustor inlet and firing temperatures. In addition fuel from different sources with different fuel gas composition is used depending on price and availability.

At the same time, emission limit values and overall emission permits are becoming more stringent, so that it is required to operate at lower emission values, keep low emissions also at part load operation, during transients, as these also count for cumulative emission limits, and for different fuel compositions.

To reduce emissions and to increase operational flexibility sequential combustion has been suggested. Depending on the operating conditions, fuel gas composition can have a large influence on the combustion stability and emission of a sequential combustor arrangement.

### SUMMARY OF THE DISCLOSURE

One object of the present disclosure is to propose a method for operating a gas turbine comprising at least a compressor, a sequential combustor arrangement, and a turbine downstream of the sequential combustor arrangement. Each sequential combustor comprises a first burner, a first combustion chamber, and a second combustor arranged sequentially in a fluid flow connection.

According to a first embodiment of the method the inlet gas is compressed in the compressor, and a fuel gas supplied to the gas turbine is separated into a rich fuel and a lean fuel. A rich fuel is a fuel which has a concentration of higher hydrocarbons (also called C2+, i.e. hydrocarbons which comprise more carbon atoms per molecule than methan, i.e. 2 or more carbon atoms per molecule) which is higher than the concentration of higher hydrocarbons of the fuel gas supplied to the separator. A lean fuel is a fuel which has a concentration of higher hydrocarbons which is lower than the concentration of higher hydrocarbons of the fuel gas supplied to the separator.

The method further comprises feeding a first fuel to at least one first burner and feeding a second fuel to at least one second combustor. The first fuel is obtained from at least one of the rich fuel, the lean fuel, and the fuel gas supplied to the gas turbine. It can be a mixture of two or all three of those gases. The concentration of higher hydrocarbons in the first fuel differs from the concentration of higher hydrocarbons of the fuel gas. The second fuel is obtained from at least one of the rich fuel, the lean fuel, and the fuel gas. It can be a mixture of two or all three of those gases. The concentration of higher hydrocarbons in the second fuel differs from the concentration of higher hydrocarbons of the fuel gas and of the first fuel.

A fuel differs in the concentration of higher hydrocarbons from another fuel if the difference can be analysed by common analyzing techniques such as for example gas chromatography. For practical reasons the difference can be for example grater than 1%, or greater than 5% in the concentration of high hydrocarbons. In order to have a big influence with a small amount of rich fuel the difference in the concentration of high hydrocarbons can be larger than 50% or even approach 100%, i.e. the lean fuel consist close to 100% of methane and the rich fuel close to 100% of high hydrocarbons (C2+).

The first fuel is burned with the compressed gas in the first combustion chamber to obtain first combustion products. The second fuel is fed to at least one second combustor and burned with the first combustion products to obtain second combustion products. These are expanded in the turbine.

The fuel gas can be separated into rich fuel and lean fuel in a gas separation system. Such a gas separation system can for example be system based on an absorption process, a cryogenic separation process, a cryogenic heat exchanger process, a cryogenic expander process, or a progressive swing adsorption process.

The second fuel can for example be admitted to a second combustor which is part of a transition zone between the first combustor and the turbine for so called late lean combustion.

According to an embodiment of the method for low load operation of the gas turbine the first fuel which is fed to the first burner is provided with a concentration of higher hydrocarbons which is lower than the concentration of higher hydrocarbons of the fuel gas supplied to the gas turbine. The second fuel which is fed to the second combustor is provided with a concentration of higher hydrocarbons which is higher than the concentration of higher hydrocarbons of the fuel gas supplied to the gas turbine for stabilizing the combustion.

Low load operation is operation in a load range from idle or minimum load up to about 50% or up to 60% relative load. In the low load range power output is typically controlled by closing variable compressor inlet guide vanes to reduce the mass flow through the gas turbine and by reducing the hot gas temperature in the second combustor. A reduction of the hot gas temperature can lead to CO emissions, unburnet hydrocarbons and flame instabilities such as pulsations. These can be mitigated by increasing the concentration of higher hydrocarbons because they reduce the ignition delay time compared to a combustion of methane. Thus, even at reduced temperatures during low load operation a complete combustion can be assured in the second combustor. The increased reactivity of higher hydrocarbons can also lead to a higher flame speed and thereby facilitates complete combustion.

Relative load can for example be defined as the actual power divided by the base load power which can be produced by the gas turbine at the respective ambient conditions.

In a further embodiment of the method for high load operation the first fuel which is fed to the first burner is provided with a concentration of higher hydrocarbons which is higher than the concentration of higher hydrocarbons of the fuel gas supplied to the gas turbine. The second fuel which is fed to the second combustor is provided with a concentration of higher hydrocarbons which is lower than the concentration of higher hydrocarbons of the fuel gas.

Depending on the fuel gas composition and the operating regime there is a risk of pre-ignition or flash back in the second combustor. The ignition delay time can typically be increased by reducing the concentration of higher hydrocarbons. Thus the proposed method allows safe operation at design hot gas temperature even when the fuel gas which is supplied to the gas turbine plant has a high concentration of higher hydrocarbons.

High load operation is operation in a load range from 60% to 100% relative load, and includes peak load with increased firing temperature or operation with power augmentation such as water or steam injection into the combustor, or high fogging (also known as wet compression).

According to a further embodiment of the method the concentration of higher hydrocarbons of the first fuel flow, of second fuel flow or of both is controlled as a function of at least one of: the gas turbine load, a temperature indicative of the load.

A temperature indicative of the gas turbine load is for example a turbine inlet temperature, a hot gas temperature, the turbine exhaust temperature or a flame temperature. A pressure indicative of the gas turbine load is for example the compressor exit pressure or a combustion pressure. These pressures or temperatures can be measured directly or estimated based on measurements taken at other locations of the gas turbine as for example bleed or cooling air temperatures and pressures.

Further, the concentration of higher hydrocarbons of the first fuel flow, of the second fuel flow or of both can be controlled as a function of the combustor pulsation level.

For example if a threshold value in pulsations indicative of an approach to a lean blow off in the second combustor is exceeded the concentration of higher-value hydrocarbon in the fuel supply to a second combustor can be increased. This can for example occur when deluding the gas turbine. Alternatively, or in combination a threshold value in pulsations indicative of high hot gas temperatures in the second combustor is exceeded the concentration of higher-value hydrocarbon in the fuel supply to a second combustor can be reduced. This can for example occur when loading the gas turbine.

According to an embodiment of the method the fuel separation is bypassed or partially bypasses and the fuel gas is directly fed to the first burner, and to the second combustor during operation in an intermediate load range. An intermediate load range can for example be in the range between 40% and 90%, or between 60% and 80% load. An overlap with low load and high load ranges is possible as the benefit of the change in fuel gas composition depends among others on the gas turbine design, the operating temperatures and the composition of the fuel gas supplied to the gas turbine.

According to another embodiment of the method dilution gas is admixed to the first combustion products before burning the mixture of first combustion products and second fuel. By admixing dilution gas the temperature in the second combustor can be reduced thereby increasing the ignition delay time. This enables better mixing of the second fuel with the first combustor products for low NOx emission and can further mitigate the pre-ignition risk in the second combustor.

According to a further embodiment of the method dilution gas is admixed to the first combustion products after injecting the second fuel. This can be used to create a homogeneous temperature profile for the turbine inlet.

Dilution gas can for example be compressed air or a mixture of air and flue gases of a gas turbine. Also compressed flue gases can be used as dilution gas. It can be injected to control the temperature and temperature distribution in the second combustor.

According to yet another embodiment the gas turbine comprises a first group of sequential combustor arrangements, and a second group of sequential combustor arrangements to increase combustion stabilities, i.e. to mitigate pulsations. The first fuel is fed to the burners of the first group of sequential combustor arrangements, and the second fuel is fed to burners the second group of sequential combustor arrangements for staging. Alternatively or in addition the first fuel is fed to the second combustors of the first group of sequential combustor arrangements, and the second fuel is fed to the second combustors of the second group of sequential combustor arrangements for staging.

Staging in this context is staging in a gas turbine with a plurality of combustor arrangements distributed circumferentially around the axis of the gas turbine. This staging can be used for annular combustors where neighbouring sequential combustor arrangements influence each other. In some annular combustors several rows of burners can be distributed in radial direction. For such arrangements also a staging between sequential combustor arrangements which are closer to the axis of the gas turbine and sequential combustor arrangements which are further away from the axis of the gas turbine can be used.

Staging of fuel composition allows to operate burners or combustors with the same hot gas temperature while changing the reaction kinetics due to the different fuel composition and thereby suppressing pulsations which might else occur when neighbouring burners or groups of burners are operated at the same temperature.

To further increase the operational flexibility and decrease the dependency on the fuel composition the rich fuel with high concentration of higher hydrocarbons (C2+) that is separated from the fuel gas when generating the lean fuel can be fed to an intermediate storage. The stored rich fuel can be used to provide a rich fuel when needed, for example during periods when the fuel gas is extremely lean, i.e. close to pure methane or when the separator is not operating. The gas separator can for example be shut-down for service or shut-down during the start-up or shut-down of the gas turbine below a minimum load or a threshold load of the gas turbine. A threshold load can for example be the houseload of the power plant, i.e. the gas turbine should produce all its internally used power before the separator is activated.

Due to spatial restrictions it might be beneficial to liquefy the separated, rich fuel prior to placing it in intermediate storage, to store it as a liquid gas and to evaporate it prior to adding into a fuel gas.

In addition to the method, a gas turbine configured for implementing the method is a subject of the disclosure. It comprises a gas turbine controller configured to operate the gas turbine according to the method.

A gas turbine according to the disclosure has a compressor, turbine and a sequential combustor arrangement comprising a first burner, a first combustion chamber, and a second combustor arranged sequentially in fluid flow connection.

The gas turbine further comprises a fuel gas supply and a fuel separation system connected to the fuel gas supply for separating a fuel gas into a rich fuel having a concentration of higher hydrocarbons which is higher than concentration of higher hydrocarbons of the fuel gas, and a lean hydrocarbon fuel having a concentration of higher hydrocarbons which is lower than concentration of higher hydrocarbons of the fuel gas. The plant further comprises a first lean fuel line with a first lean fuel control valve which connects the outlet for lean fuel of the fuel separation system with the first burner, and a first rich fuel line with a first rich fuel control valve which connects the outlet for rich fuel of the fuel separation system with the first burner. The plant also comprises a second lean fuel line with a second lean fuel control valve which connects the outlet for lean fuel of the fuel separation system with the second combustor, and a second rich fuel line with a second rich fuel control valve which connects the outlet for rich fuel of the fuel separation system with the second combustor.

According to one embodiment the gas turbine comprises first bypass line with a first bypass control valve which connects the fuel gas supply with the first burner for bypassing the fuel separation system. Alternatively or in addition it comprises a second bypass line with a second bypass control valve which connects the fuel gas supply with the second combustor for bypassing the fuel separation system.

The first rich fuel line and first lean fuel line can be joined upstream of the first burner for feeding a mixture of both fuels to the first burner. Also the the second rich fuel line and second lean fuel line are joined upstream of the second combustor for feeding a mixture of both fuels to the second combustor. For arrangements with bypass lines these can join the first and second fuel lines before the first burner, and before the second combustor, respectively.

According to one embodiment the combustor arrangement comprises an injector for admixing dilution gas to the first combustion products arranged downstream of the first combustion chamber and upstream of a second reaction zone in the second combustor.

According to a further embodiment the second combustor comprises a dilution gas admixer for admixing a dilution gas to the first combustion products leaving the first combustion chamber, a second burner for admixing the second fuel, and a second combustion chamber. The dilution gas admixer, the second burner and second combustion chamber are arranged sequentially in a fluid flow connection, i.e. the exit of the dilution gas admixer is connected to the inlet of the second burner and the exit of the burner is connected to the inlet of the second combustion chamber.

The first combustor and second combustor can be part of a combustor arrangement configured to operate at practically the same pressure, i.e. the difference in operating pressure is only caused by the pressure loss of the gas flowing from the first combustor to the second, and which might be needed for good mixing of the first combustion products with the second fuel plus optionally for the admixing of a dilution gas. Typically the pressure loss of the sequential combustor arrangement is less than 10% of the inlet pressure of the first burner, for example in the range of 3% to 6%. The inlet of the second combustor can be connected to the exit of the first combustion chamber without an interposed turbine.

According to yet a further embodiment the combustor arrangement comprises a first group of sequential combustor arrangements and a second group of sequential combustor arrangements. The first burners of the first group of sequential combustor arrangements are connected to the fuel line for the first fuel, and the first burners of the second group of sequential combustor arrangements are connected to the fuel line for second fuel for staging. Alternatively, or in combination the second combustors of the first group of sequential combustor arrangements are connected to the fuel line for the first fuel, and the second combustors of the second group of sequential combustor arrangements are connected to the fuel line for second fuel for staging. In other words individual burners or combustors or groups of burners or combustors are supplied for example alternatingly with the first fuel or the second fuel.

Typically such a sequential combustor arrangement comprises sequential combustors in a can architecture. The sequential combustor arrangement can also be in an annular arrangement with an annular first combustion chamber downstream of the first burners. The second combustors can also be arranged in annular architectures. A combination of can architecture first combustion chambers and annular second combustors or annular first combustion chambers and can architecture second combustors is also conceivable.

For the sequential combustor arrangement different burner types can be used. For example so called EV burner as known for example from the EP 0 321 809 or AEV burners as known for example from the DE195 47 913 can be used as first burner. Also a BEV burner comprising a swirl chamber as described in the European Patent application EP12189388.7, which is incorporated by reference, can be used. Further, a flame sheet combustor as described in US2004/0211186, which is incorporated by reference, can be used as first combustor.

The second combustor can simply comprise a second fuel injection followed by a reaction zone.

### BRIEF DESCRIPTION OF THE DRAWINGS

The disclosure, its nature as well as its advantages, shall be described in more detail below with the aid of the accompanying schematic drawings.

Referring to the drawings:

FIG. 1 shows a gas turbine with a compressor, a sequential combustion arrangement, and a turbine;

FIG. 2 shows a sequential combustion arrangement with a first burner, first combustion chamber, and a second combustor with a fuel separation system to supply different fuel qualities to the first burner and to the second combustor;

FIG. 3 shows a second example of a combustion system for a gas turbine with a fuel separation system and a dilution gas admixer;

FIG. 4 shows a gas turbine with a sequential combustion arrangement with a first burner, a first combustion chamber, a second burner with dilution gas admixer and a fuel injection followed by a second combustion chamber with a second combustion zone;

FIG. 5 shows a cross section of the sequential combustor arrangement with a fuel gas distribution system for circumferential staging.

### EMBODIMENTS OF THE DISCLOSURE

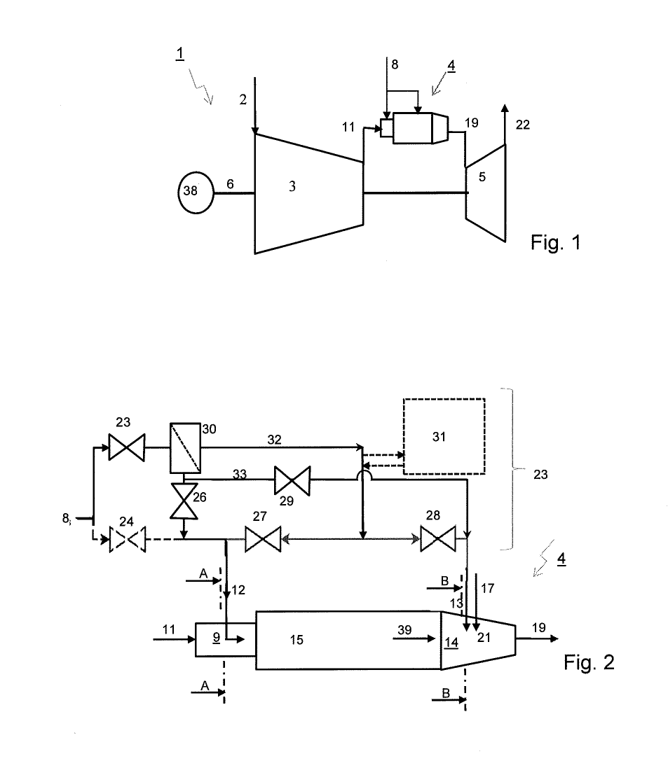

FIG. 1 shows a gas turbine 1 with a sequential combustor arrangement 4. It comprises a compressor 3, a sequential combustor arrangement 4, and a turbine 5.

Intake air 2 is compressed to compressed gas 11 by the compressor 3. Fuel gas 8 is supplied to subsequent locations of the sequential combustor arrangement and burned with the compressed gas 11 in the sequential combustor arrangement 4 to generate second combustion products 19. These are expanded in the turbine 5 generating mechanical work.

The gas turbine system can be coupled to a generator 38 via a shaft 6 of the gas turbine 1. Typically, a gas turbine 1 further comprises a cooling system for the turbine 5 and sequential combustor arrangement 4, which is not shown as it is not the subject of this disclosure.

Exhaust gases 22 leave the turbine 5. The remaining heat of the exhaust gases 22 is typically used in a subsequent water steam cycle, which is also not shown here.

A first example of a sequential combustor arrangement 4 according to the disclosure is shown in FIG. 2. This sequential combustor arrangement 4 comprises a first burner 9 into which the compressed gas 11 and the first fuel 12 are admitted. The mixture of compressed gas 11 and first fuel 12 is burned in the first combustion chamber 15 generating first combustion products 39. These flow into the second combustor 14 arranged downstream of the first combustion chamber.

The second combustor 14 comprises a dilution gas injection 17 and an injection for a second fuel 13. The mixture of first combustion products 39, dilution gas 17 and second fuel 13 react in the second reaction zone 21 of the second combustor 14 forming second combustion products 19 which leave the second combustor 14 and are admitted to the turbine.

The gas turbine 4 has a common fuel gas supply 8. The fuel system 46 comprises a fuel separation system 30 to separate an incoming fuel gas 8 into a rich fuel 32 having a concentration of higher hydrocarbons which is higher than concentration of higher hydrocarbons of the fuel gas 8, and a lean fuel 33 having a concentration of higher hydrocarbons which is lower than the concentration of higher hydrocarbons of the fuel gas 8. A fuel gas separator inlet control valve 23 is arranged in the line connecting the fuel gas 8 supply to the fuel separation system 30.

A line for rich fuel 32 leaving the fuel separation system is split into two lines. One line is connected to a line feeding the first fuel 12 to the first burner 9. A first rich fuel control valve 27 is arranged in this line to control the flow of rich fuel 32 to the first burner 9.

Another line for rich fuel 32 is connected to a line feeding the second fuel 13 to the second combustor 14. A second rich fuel control valve 28 is arranged in this line to control the flow of rich fuel 32 to the second combustor 14.

An optional rich fuel storage 31 can be connected to the fuel separator via the line for rich fuel 32. This allows the storage of rich fuel in case of excess production or keep a stock of rich fuel for example for times when only lean fuel is available as fuel gas 8 from the fuel gas supply.

A line for lean fuel 33 leaving the fuel separation system is split into two lines. One line is connected to a line feeding the first fuel 12 to the first burner 9. A first lean fuel control valve 26 is arranged in this line to control the flow of lean fuel 33 to the first burner 9. Another line for lean fuel 33 is connected to a line feeding the second fuel 13 to the second combustor 14. A second lean fuel control valve 29 is arranged in this line to control the flow of lean fuel 33 to the second combustor 14.

The line from the second rich fuel control valve 28 and second lean control valve 29 are joint and connected to the second combustor 14 for supplying it with the second fuel 13.

The line from the first rich fuel control valve 27 and first lean fuel control valve 26 are joint and connected to the first burner 9 for supplying it with the first fuel 12.

In addition an optional line for fuel gas 8 is arranged to bypass the fuel separation system 30 and connects the fuel supply directly to the line for the first fuel 12. A first bypass control valve 24 is arranged in this line and controls the optional bypass flow of fuel gas 8 which can be directly fed to the first burner 9.

In this embodiment with a can architecture the first combustion chamber 15 has a smooth cylindrical flow path. The transition from a circular cross section of the first combustion chamber 15 to a cross section with a shape of a section of an annulus or practically rectangular flow cross section at the outlet, i.e. at the turbine inlet, is integrated into the second combustor 14.

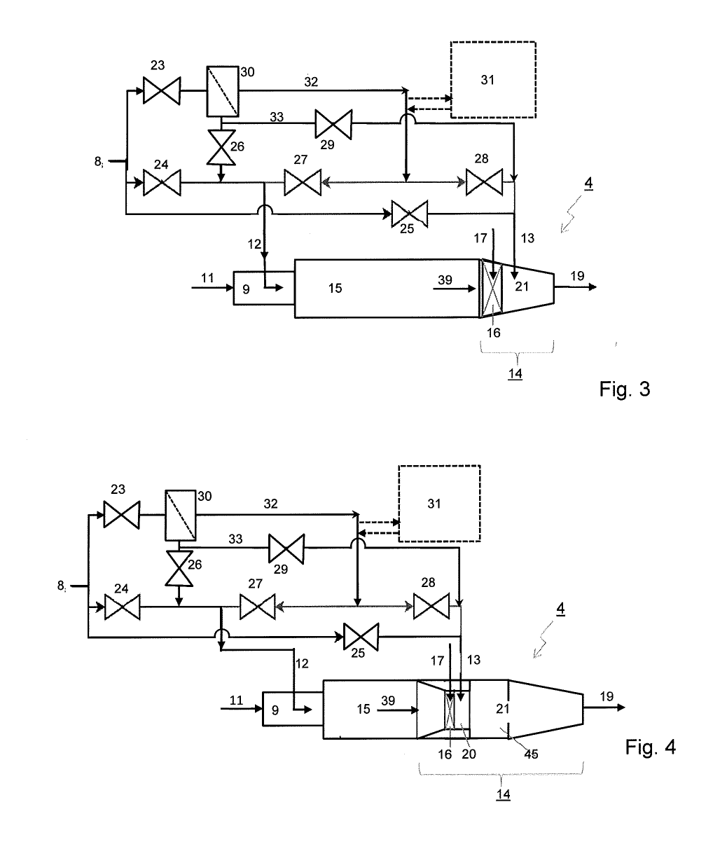

The embodiments of FIGS. 3 and 4 are based on FIG. 2. The fuel system of the examples of FIGS. 3 and 4 comprise a further line for fuel gas 8 for bypassing the fuel separation system 30. This line connects the fuel supply directly to the line for the second fuel 13. A second bypass control valve 25 is arranged in this line and controls the bypass flow of fuel gas 8 which can be directly fed to the second combustor 14.

The example of FIG. 3 further comprises a mixer 16 for admixing of dilution gas. The first combustion products 39 are admitted to the second combustor 14 at an upstream end. Dilution gas 17 is admixed in a mixer 16 which is integrated into the second combustor 14.

The example of FIG. 4 further comprises a second burner 20 with a mixer 16 for admixing of dilution gas. The first combustion products 39 are admitted to the second burner 20 and second fuel 13 is injected into the second burner 20 and mixed with the first combustion products 39, and dilution gas 17. The second fuel 13 can also be admitted to the mixer 16 and mixed with the first combustion products 39 and dilution gas 17 in the mixer 16 (not shown here). Downstream of the second burner 20 a second combustion chamber with a second reaction zone 21 is arranged. In this example the cross section of the flow path of the second burner 20 at the outlet is smaller than the cross section of the subsequent second reaction zone 21 for flame stabilization at the inlet of the second combustion chamber.

In all examples dilution gas 17 (not shown) can also be injected together with the first fuel 12 and second fuel 13.

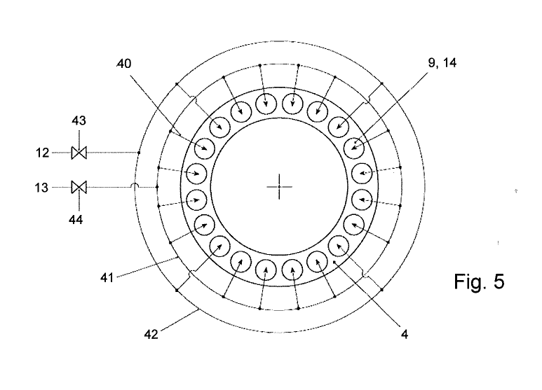

FIG. 5 shows an optional design of the cross section A-A, respectively B-B of FIG. 2. Section A-A is a cut through the first burner 9 and section B-B a cut through the second combustor 14. FIG. 5 shows an example of a fuel distribution system with two fuel distribution rings 41, 42. The first fuel distribution ring 41 is connected to the fuel line via a first fuel staging valve 43. The second fuel distribution ring 42 is connected to the second fuel line via a second fuel staging valve 44.

The first burners 9, respectively the second combustors 14 are alternatingly connected to the first fuel distribution ring 41 and to the second fuel distribution ring 42 via fuel feeds 40. The first burners 9, respectively the second combustors 14 can also be connected in pair arrangements or other groups of 3 or more, which can be advantageous to mitigate pulsations.

For all shown arrangements can or annular architectures or any combination of the two is possible.

All the explained advantages are not limited to the specified combinations but can also be used in other combinations or alone without departing from the scope of the disclosure. Other possibilities are optionally conceivable, for example the dilution gas 17 can be re-cooled in a cooling gas cooler before use as dilution gas.

### LIST OF DESIGNATIONS

1 Gas turbine
2 Intake air
3 Compressor
4 Sequential combustor arrangement
5 Turbine
6 Shaft
7 Sequential combustor
8 Fuel gas
9 First burner
10 Fuel feed
11 Compressed gas
12 First fuel
13 Second fuel
14 Second combustor
15 First combustion chamber
16 Mixer
17 Dilution gas
19 Second combustion Products
20 Second burner
21 Second reaction zone
22 Exhaust Gas
23 Fuel separator inlet control valve
24 First bypass control valve
25 Second bypass control valve
26 First lean fuel control valve
27 First rich fuel control valve
28 Second rich fuel control valve
29 Second lean fuel control valve
30 fuel separation system
31 rich fuel storage
32 rich fuel
33 lean fuel
38 Generator
39 First combustion products
40 Fuel feed
41 First fuel distribution ring
42 second fuel distribution ring
43 First fuel staging valve
44 Second fuel staging valve
45 Second combustion chamber
46 Fuel system

1. Method for operating a gas turbine plant with a compressor, a turbine, and a sequential combustor arrangement having a first burner, a first combustion chamber, and a second combustor the method comprising:
compressing an inlet gas in the compressor,
separating a fuel gas into a rich fuel having a concentration of higher hydrocarbons which is higher than a concentration of higher hydrocarbons of the fuel gas, and a lean fuel having a concentration of higher hydrocarbons which is lower than the concentration of higher hydrocarbons of the fuel gas,
feeding a first fuel having at least one of the rich fuel, the lean fuel, and the fuel gas or a mixture thereof to at least one first burner wherein a concentration of higher hydrocarbons in the first fuel differs from the concentration of higher hydrocarbons of the fuel gas,
burning the first fuel and the compressed gas in the first combustion chamber to obtain first combustion products,
feeding a second fuel having at least one of the rich fuel, the lean fuel, and the fuel gas or a mixture thereof to at least one second combustor wherein an concentration of higher hydrocarbons in the second fuel differs from the concentration of higher hydrocarbons of the fuel gas and of the first fuel,
burning the second fuel with the first combustion products to obtain second combustion products, and
expanding the second combustion products in the turbine.

2. The method according to claim 1, wherein for low load operation the method comprises:
providing the first fuel which is fed to the first burner with a concentration of higher hydrocarbons which is lower than the concentration of higher hydrocarbons of the fuel gas, and
providing the second fuel which is fed to the second combustor with a concentration of higher hydrocarbons which is higher than the concentration of higher hydrocarbons of the fuel gas for stabilizing combustion.

3. The method according to claim 1, wherein for high load operation the method comprises:
providing the first fuel which is fed to the first burner with a concentration of higher hydrocarbons which is higher than the concentration of higher hydrocarbons of the fuel gas, and
providing the second fuel which is fed to the second combustor with a concentration of higher hydrocarbons which is lower than the concentration of higher hydrocarbons of the fuel gas for reducing flame speed.

4. The method according to claim 1, comprising:
controlling the concentration of higher hydrocarbons of the first fuel flow and/or of second fuel flow as a function of at least one of: the gas turbine load, a temperature indicative of the load, a pressure indicative of the load, or combustion pulsations.

5. The method according to claim 1, comprising:
during operation in an intermediate load range, bypassing fuel separation and directly feeding the fuel gas to the first burner, and to the second combustor.

6. The method according to claim 1, comprising:
admixing dilution gas to the first combustion products before burning a mixture of first combustion products and second fuel.

7. The method according to claim 1, comprising:
admixing dilution gas to the first combustion products after injecting the second fuel.

8. The method according to claim 1, wherein the gas turbine plant includes a first group of sequential combustor arrangements, and a second group of sequential combustor arrangements, wherein the method comprises:
feeding the first fuel to the burners of first group of sequential combustor arrangements, and feeding the second fuel to burners of the second group of sequential combustor arrangements for staging, and/or
feeding the first fuel to the second combustors of the first group of sequential combustor arrangements, and feeding the second fuel is fed to the combustors of the second group of sequential combustor arrangements for staging.

9. A gas turbine plant with a compressor, turbine and a sequential combustor arrangement comprising:
a first burner, a first combustion chamber, and a second combustor arranged sequentially in fluid flow connection,
a fuel gas supply and a fuel separation system connected to the fuel gas supply for separating a fuel gas into a rich fuel having a concentration of higher hydrocarbons which is higher than a concentration of higher hydrocarbons of the fuel gas, and a lean fuel having a concentration of higher hydrocarbons which is lower than a concentration of higher hydrocarbons of the fuel gas,
a first lean fuel line with a first lean fuel control valve, connecting the fuel separation system with the first burner, and a first rich fuel line with a first rich fuel control valve connecting the fuel separation system with the first burner: and
a second lean fuel line with a second lean fuel control valve, connecting the fuel separation system with the second combustor, and a second rich fuel line with a second rich fuel control valve connecting the fuel separation system with the second combustor.

10. A gas turbine plant according to claim 9, comprising:
a first fuel gas line with a first fuel gas control valve connecting the fuel gas supply with the first burner for bypassing the fuel separation system, and/or
a second fuel gas line with a second fuel gas control valve connecting the fuel gas supply with the second combustor for bypassing the fuel separation system.

11. A gas turbine plant according to claim 9, wherein the combustor arrangement comprises:
an injector for admixing dilution gas to the first combustion products, arranged downstream of the first combustion chamber and upstream of a second reaction zone in the second combustor.

12. A gas turbine plant according to claim 9, wherein the second combustor comprises:
an a dilution gas admixer for admixing a dilution gas to the first combustion products when leaving the first combustion chamber,
a second burner for admixing the second fuel, and a second combustion chamber, wherein the dilution gas admixer, the second burner and
second combustion chamber are arranged sequentially in a fluid flow connection

13. A gas turbine plant according to claim 9, wherein an exit of the first combustion chamber is connected to the second combustor without an interposed turbine.

14. A gas turbine plant according to claim 9, wherein the gas turbine plant comprises:
a first group of sequential combustor arrangements and a second group of sequential combustor arrangements, wherein
the fuel line for a first fuel is connected to the first burners of the first group of sequential combustor arrangements, and wherein the fuel line for a second fuel is connected to the first burners of the second group of sequential combustor arrangements for staging, and/or
the fuel line for the first fuel is connected to the second combustors of the first group of sequential combustor arrangements, and wherein the fuel line for the second fuel is connected to the second combustors of the second group of sequential combustor arrangements for staging.

15. A gas turbine plant according to claim 9, comprising:
a gas turbine controller configured to operate the gas turbine plant, the controller being configured to execute a method that includes:
compressing an inlet gas in the compressor,
separating a fuel gas into a rich fuel having a concentration of higher hydrocarbons which is higher than a concentration of higher hydrocarbons of the fuel gas, and a lean fuel having a concentration of higher hydrocarbons which is lower than the concentration of higher hydrocarbons of the fuel gas,
feeding a first fuel having at least one of the rich fuel, the lean fuel, and the fuel gas or a mixture thereof to at least one first burner wherein a concentration of higher hydrocarbons in the first fuel differs from the concentration of higher hydrocarbons of the fuel gas,
burning the first fuel and the compressed gas in the first combustion chamber to obtain first combustion products,
feeding a second fuel having at least one of the rich fuel, the lean fuel, and the fuel gas or a mixture thereof to at least one second combustor wherein an concentration of higher hydrocarbons in the second fuel differs from the concentration of higher hydrocarbons of the fuel gas and of the first fuel,
burning the second fuel with the first combustion products to obtain second combustion products, and
expanding the second combustion products in the turbine.
